(19) United States
(12) Patent Application Publication
(10) Pub. No.: US 2010/0161207 A1
(43) Pub. Date: Jun. 24, 2010

(54) MOBILE TERMINAL AND METHOD FOR PROVIDING LOCATION-BASED SERVICE THEREOF

(76) Inventor: In-Young DO, Seoul (KR)

Correspondence Address: BIRCH STEWART KOLASCH & BIRCH, PO BOX 747, FALLS CHURCH, VA, 22040-0747, US

(21) Appl. No.: 12/499,668

(22) Filed: Jul. 8, 2009

(30) Foreign Application Priority Data
Dec. 24, 2008 (KR) 10-2008-0133967

(51) Int. Cl. H04W 4/02; G01C 21/00

(52) U.S. Cl. 701/200; 455/456.3

(57) ABSTRACT

A mobile terminal and method for providing a location-based service of the mobile terminal. The mobile terminal includes: a user input unit configured to receive an input for selecting a certain point whose geographical information is desired to be received; a wireless communication unit configured to receive location information including omnidirectional visual information collected by an information collecting terminal installed at a position related to the selected certain point; a controller configured to generate visual information related to the certain point by using the received location information; and an output unit configured to display the generated visual information.

### CROSS-REFERENCE TO A RELATED APPLICATION

The present application claims priority to Korean Application No. 10-2008-0133967, filed in Korea on Dec. 24, 2008, which is herein expressly incorporated by reference in its entirety.

### BACKGROUND OF THE INVENTION

1. Field of the Invention

The present invention relates to a mobile terminal providing visual omnidirectional information about a certain point and a method for providing a location-based service of the mobile terminal.

2. Description of the Related Art

Terminals may be divided into a mobile terminal (portable terminal) and a stationary terminal according to whether the terminal is portable or not. The mobile terminals may be divided into a handheld terminal that can be directly carried around and a vehicle mount terminal.

The terminals may be multimedia players having complex functions such as capturing images or video, reproducing music or video files, playing games, receiving broadcasts, etc.

Multimedia services provided by mobile terminals may include a location-based service (LBS) providing various services that use location information. Examples of a LBS may include a route guidance service providing a route guidance from the user's location and a start point to a destination, a map service providing composite geographical information such as latitude and longitude of a certain point on a map, roads, dispositions of buildings, and the like.

The mobile terminal providing the LBS may be implemented as a navigation terminal installed in or detachably attached to a moving object to provide information required for operating the moving object to the user.

In addition, the mobile terminal providing LBS may be configured so as to be carried around by the user.

### SUMMARY OF THE INVENTION

Therefore, in order to address the above matters, various features described herein have been conceived.

An aspect of the exemplary embodiments provides a mobile terminal including: a user input unit configured to receive an input for selecting a certain point whose geographical information is desired to be received; a wireless communication unit configured to receive location information including omnidirectional visual information collected by an information collecting terminal installed at a position related to the selected certain point; a controller configured to generate visual information related to the certain point by using the received location information; and an output unit configured to display the generated visual information.

Another aspect of the present invention provides a method for providing a location-based service (LBS) of a contents mobile terminal, including: receiving an input for selecting a certain point whose geographical information is desired to be received; receiving location information including omnidirectional visual information collected by an information collecting terminal installed at a position related to the selected certain point; and displaying visual information related to the certain point by using the received location information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates how a mobile terminal, an information collecting terminal and a location-based service (LBS) server interwork according to an embodiment of the present invention;

FIG. 2 is a schematic block diagram of a mobile terminal according to an embodiment of the present invention;

FIG. 3 is a flow chart illustrating the process of a method for providing a LBS for the mobile terminal according to a first embodiment of the present invention;

FIG. 4 is an overview of a display screen of the mobile terminal according to an embodiment of the present invention;

FIG. 5 is an overview of a display screen illustrating an indication of a certain point where the information collecting terminal is installed according to an embodiment of the present invention;

FIG. 6 is an overview of a display screen illustrating a selection of a certain point by the user in the mobile terminal according to an embodiment of the present invention;

FIGS. 7a to 7c are overviews of display screens illustrating the provision of visual information in the mobile terminal according to an embodiment of the present invention;

FIGS. 8a and 8b are overviews of display screens illustrating additional information displayed in a navigation terminal according to an embodiment of the present invention;

FIG. 9 is a flow chart illustrating a method for providing a LBS for the mobile terminal according to a second embodiment of the present invention;

FIGS. 10a and 10b are overviews of display screens illustrating displays of advertisement information in the mobile terminal according to an embodiment of the present invention;

FIG. 11 is a flow chart illustrating a method for providing a LBS for the mobile terminal according to a third embodiment of the present invention; and

FIG. 12 is a flow chart illustrating a method for providing a LBS for the mobile terminal according to a fourth embodiment of the present invention.

### DETAILED DESCRIPTION OF THE INVENTION

Exemplary embodiments of the present invention will now be described with reference to the accompanying drawings, in which the same reference numerals are used for the same or corresponding elements and repeated description are omitted.

In the following description, suffixes such as ‘module’, ‘part’ or ‘unit’ used for referring to elements are given merely to facilitate explanation of the present invention, without having any significant meaning by itself.

A mobile terminal according to an embodiment of the present invention may be implemented in the form of a vehicle mobile terminal mounted in a vehicle to constitute a car navigation system (CNS) or another type of navigation system.

The mobile terminal described in the present invention may be configured to be carried around by the user and may be implemented as a mobile phone that includes a location information module, a smart phone, a notebook computer, a digital broadcast terminal, a PDA (Personal Digital Assistant), a PMP (Portable Multimedia Player), etc.

The term “moving object” described in the present invention may refer to the user of the mobile terminal, in addition to a mobile transportation unit such as a motorized ground vehicle (e.g., automobile, bus, truck, motorcyle), a ship, an aircraft, and the like. The location of the moving object may be recognized to be essentially the same as the location of the mobile terminal.

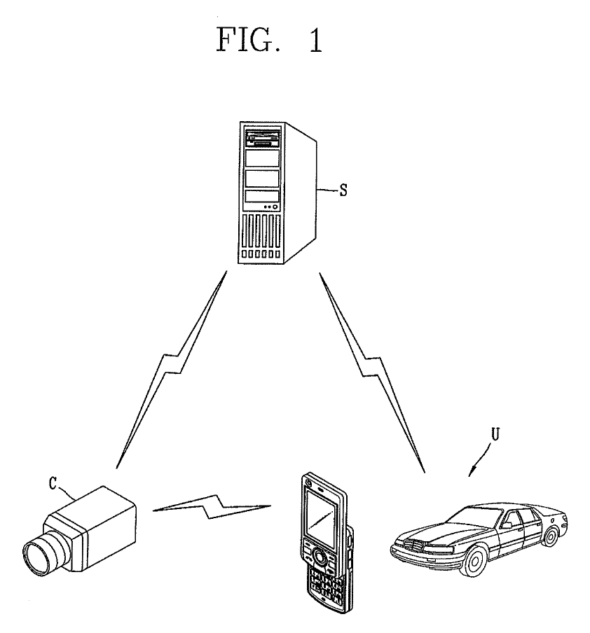

FIG. 1 illustrates a mobile terminal, an information collecting terminal and a location-based service (LBS) server according to an embodiment of the present invention.

As shown in FIG. 1, the information collecting terminal (C) may be installed at a location related to a certain point whose geographical information is desired to be acquired by the user. One or a plurality of information collecting terminals (C) may be installed at the location related to the certain point.

The location related to the certain point may refer to a location at which an image of the certain point can be easily captured or a location at which omnidirectional visual information can be easily collected from the certain point. The certain point may include locations related to one or a plurality of certain points.

The information collecting terminal (C) may include one or a plurality of cameras, and the camera may capture a fixed time point to generate a still image or video. When the information collecting terminal (C) includes a plurality of cameras, each camera may be installed such that a still image or video captured by each camera include omnidirectional visual information.

The information collecting terminal (C) may include a wireless communication unit. The wireless communication unit may transmit the location information collected by the information collecting terminal (C) to the location-based service server (S) or the mobile terminal 100.

As shown in FIG. 1, the location-based service server (S) may store location information collected by the information collecting terminal (C) and location information collected by the mobile terminal 100 or other server (not shown).

The location-based service server (S) may relay wireline/wireless communication between the information collecting terminal (C) and the mobile terminal 100 or transmit the location information stored in the location-based service server (S) to the mobile terminal 100.

As shown in FIG. 1, the mobile terminal 100 may be implemented in the form of the vehicle navigation terminal mounted in the vehicle or the mobile terminal 100 fabricated to be carried around by the user, receive the location information from the information collecting terminal (C) or the location-based service server (S).

The mobile terminal 100 may detect whether or not the information collecting terminal (C) is present at a location where the information collecting terminal (C) can communicate with the mobile terminal 100. For example, the mobile terminal 100 may transmit a signal requesting a response to the information collecting terminal (C). When the information collecting terminal (C) is located at a position available for communication with the mobile terminal 100, the information collecting terminal (C) may transmit a response signal to the mobile terminal 100 in response to the request. Thus, if the mobile terminal 100 receives a response signal from the information collecting terminal (C), the mobile terminal 100 may determine that the information collecting terminal (C) is at a communication available location.

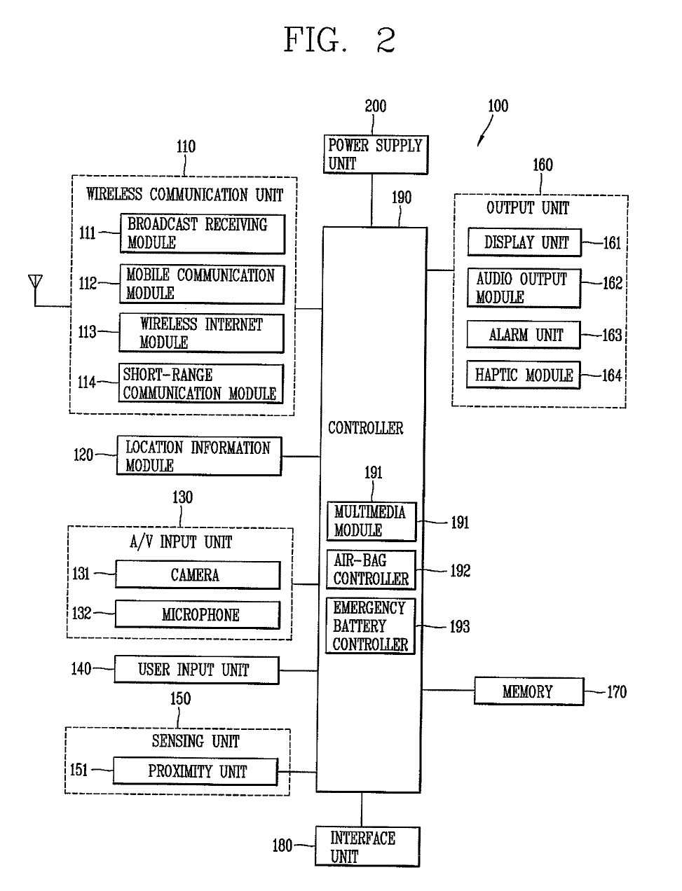

FIG. 2 is a schematic block diagram of a mobile terminal according to an embodiment of the present invention.

The mobile terminal 100 may include a wireless communication unit 110, a location information module 120, an A/V (Audio/Video) input unit 130, a user input unit 140, a sensing unit 150, an output unit 160, a memory 170, an interface unit 180, a controller 190, and a power supply unit 200, and the like. FIG. 2 shows the mobile terminal as having various components, but it should be understood that implementing all of the illustrated components is not a requirement. Greater or fewer components may alternatively be implemented.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114.

The broadcast receiving module 111 receives broadcast signals and/or broadcast associated information from an external broadcast management server (or other network entity) via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 170 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 120 is a module for acquiring a location (or position) of the mobile terminal. For example, the location information module 120 may be embodied by using a GPS (Global Positioning System) module

The GPS module may receive signals including time information from three or more navigation satellites and calculates the distance from each satellite by using the signals. The accuracy of the calculated location information can be improved by applying techniques such as map matching, dead reckoning, and the like, to the location information obtained by applying triangulation scheme to the calculated distance.

The location information module 120 may obtain location information by using various techniques such as cell tower signals, wireless Internet signals, Bluetooth sensors, and the like, to recognize the location of the mobile terminal. Such techniques are called a hybrid positioning system.

The location of the mobile terminal 100 detected by the location information module 120 may refer to the location of a moving object.

The A/V input unit 130 is configured to receive an audio or video signal. The A/V input unit 130 may include a camera 131 (or other image capture device) and a microphone 132 (or other sound pick-up device). The camera 131 processes image data of still pictures or video obtained by an image capture device in a video capturing mode or an image capturing mode. The processed image frames may be displayed on a display unit 161 (or other visual output device).

The image frames processed by the camera 131 may be stored in the memory 170 (or other storage medium) or transmitted via the wireless communication unit 110. Two or more cameras 131 may be provided according to the configuration of the mobile terminal.

The microphone 132 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 132 may implement various types of noise canceling (or suppression) algorithms to cancel (or suppress) noise or interference generated in the course of receiving and transmitting audio signals.

The user input unit 140 (or other user input device) may generate input data for controlling the operation of the mobile terminal of the user. The user input unit 140 may include a keypad, a dome switch, a touch pad (e.g., a touch sensitive member that detects changes in resistance, pressure, capacitance, etc. due to being contacted) a jog wheel, a jog switch, and the like.

When the mobile terminal 100 is the vehicle navigation device 100, a steering wheel, an acceleration pedal, a brake pedal, a gear shift, and the like, mounted in a vehicle may constitute the user input unit 140.

The sensing unit 150 (or other detection means) detects the presence or absence of user contact with the mobile terminal 100 (i.e., touch inputs), whether or not power of the power supply unit 200 is supplied, whether or not the interface unit 180 is combined with an external device or a vehicle component. Meanwhile, the sensing unit 150 may include a proximity sensor 151.

The sensing unit 150 may include sensors for detecting a motion of a moving object, for example, a speed sensor for detecting a movement speed of the moving object, a G-sensor for detecting acceleration, a gyro sensor for detecting a rotational angular velocity or a rotation angular acceleration of the moving object, and the like. The sensors for detecting the movement of the moving object may be utilized as a dead reckoning (DR) sensor. The DR sensor may be included in the location information module 120 or interwork with the location information module 120 so as to be used to detect the location of the moving object.

When the mobile terminal 100 is the vehicle navigation device 100, the sensing unit 150 may detect a current of the mobile terminal or the vehicle such as whether or not a vehicle window is open or closed, whether or not a security belt is worn, a manipulation state of a steering wheel of a driver, an acceleration pedal, a break pedal and a gear lever, the temperature of the interior or exterior of the vehicle, whether or not the vehicle collides with an object or a collision strength, the distance between the vehicle and the object, a state of the components mounted in the vehicle, a blinking state or brightness of a lamp mounted at the interior or exterior of the vehicle, and generate a sensing signal for controlling the operation of the vehicle or the mobile terminal 100. For example, the sensing unit 150 may detect whether or not the vehicle door is open, and if a passenger is seated in the vehicle, the sensing unit 150 may detect the pressure applied to the seat by using a pressure sensor.

The output unit 160 is configured to provide outputs in a visual, audible, and/or tactile manner (e.g., audio signal, video signal, alarm signal, vibration signal, etc.). The output unit 160 may include the display unit 161, an audio output module 162, an alarm unit 163, a haptic module 164, and the like.

The display unit 161 may display information processed in the mobile terminal 100. For example, when the mobile terminal 100 is in route search mode, the display unit 161 may display a User Interface (UI) or a Graphic User Interface (GUI) associated with a route search. When the mobile terminal 100 is in a video call mode or image capturing mode, the display unit 161 may display a captured image and/or received image, a UI or GUI that shows videos or images and functions related thereto, and the like.

The display unit 161 may include at least one of a Liquid Crystal Display (LCD), a Thin Film Transistor-LCD (TFT-LCD), an Organic Light Emitting Diode (OLED) display, a flexible display, a three-dimensional (3D) display, or the like.

Some of the components of the display unit 161 may be configured to be transparent or light-transmissive to allow viewing of the exterior. These components may be called transparent displays. A typical transparent display may be, for example, a TOLED (Transparent Organic Light Emitting Diode) display, or the like.

The display unit 161 may be implemented in the form of a head up display (HUD). For example, the display unit 161 may be implemented on a front glass or a window of the door of the vehicle. In this case, the display unit 161 may be configured to be transparent or light-transmissive.

The mobile terminal 100 may include two or more display units 161 (or other display means) according to its particular desired embodiment. For example, a plurality of display units may be separately or integrally disposed on a single surface (the same surface), or may be disposed on each different surface.

Meanwhile, when the sensor (referred to as ‘touch sensor’, hereinafter) for detecting a touch operation of the display unit 161 is overlaid in a layered manner (referred to as a ‘touch screen’), the display unit 161 may function as both an input device and an output device. The touch sensor may have, for example, the form of a touch film, a touch sheet, a touch pad, and the like.

The touch sensor may be configured to convert the pressure applied to a particular portion of the display unit 161 or a change in capacitance generated at a particular portion of the display unit 161 into an electrical input signal. The touch sensor may be configured to detect a touch input pressure as well as a touch input position and a touch input area.

When there is a touch input with respect to the touch sensor, the corresponding signal(s) are sent to a touch controller (not shown). The touch controller processes the signal(s) and transmits corresponding data to the controller 190. Accordingly, the controller 190 can recognize a touched region of the display unit 161.

The proximity sensor 151 may be disposed within or near the touch screen. The proximity sensor 151 is a sensor for detecting the presence or absence of an object relative to a certain detection surface or an object that exists nearby by using the force of electromagnetism or infrared rays without a physical contact. Thus, the proximity sensor 151 has a considerably longer life span compared with a contact type sensor, and it can be utilized for various purposes.

Examples of the proximity sensor 151 may include a transmission type photo sensor, a direct reflection type photo sensor, a mirror-reflection type photo sensor, an RF oscillation type proximity sensor, a capacitance type proximity sensor, a magnetic proximity sensor, an infrared proximity sensor, and the like. If the touch screen is the capacitance type, it is configured to detect a proximity of the pointer based on a change in an electric field according to approaching of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, the pointer is positioned to correspond vertically to the touch screen.

The proximity sensor 151 may detect a proximity touch and a proximity touch pattern (e.g., a proximity touch distance, a proximity touch speed, a proximity touch time, a proximity touch position, a proximity touch movement state, or the like), and output information corresponding to the detected proximity touch operation and the proximity touch pattern to the touch screen.

The audio output module 162 may output audio data received from the wireless communication unit 110 or stored in the memory 170 in a call signal reception mode, a call mode, a record mode, a voice recognition mode, a broadcast reception mode, a route search mode, and the like. Also, the audio output module 162 may provide audible outputs related to a particular function (e.g., a call signal reception sound, a message reception sound, a route guidance voice, etc.) performed by the mobile terminal 100. The audio output module 162 may include a receiver, a speaker, a buzzer, or other sound generating device.

The alarm unit 163 (or other type of user notification means) may provide outputs to inform about the occurrence of an event of the mobile terminal 100. Typical events may include call reception, message reception, key signal inputs, a touch input, an abnormal state of components mounted in the vehicle, abnormal opening and closing of the vehicle door or window, etc. In addition to audio or video outputs, the alarm unit 163 may provide outputs in a different manner to inform about the occurrence of an event. For example, the alarm unit 163 may provide an output in the form of vibrations (or other tactile or sensible outputs). When a call, a message, or some other incoming communication is received, the alarm unit 163 may provide tactile outputs (i.e., vibrations) to inform the user thereof. Also, when a key input signal is inputted, the alarm unit 163 may vibrate the mobile terminal 100 via a vibration means as a feedback with respect to the key signal input. By providing such tactile outputs, the user can recognize the occurrence of various events. A signal for information about the occurrence of events may be also outputted via the display unit 161 or the audio output module 162, so the display unit 161 and the audio output module 162 may be classified as part of the alarm unit 163.

The haptic module 164 generates various tactile effects the user may feel. A typical example of the tactile effects generated by the haptic module 164 is vibration. The strength and pattern of the haptic module 164 can be controlled. For example, different vibrations may be combined to be outputted or sequentially outputted.

The haptic module 164 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 164 may be implemented to allow the user to feel a tactile effect through a muscle sensation such as fingers or arm of the user, as well as transferring the tactile effect through a direct contact. Two or more haptic modules 164 may be provided according to the configuration of the mobile terminal 100.

If the mobile terminal 100 is the vehicle mobile terminal 100, the haptic module 164 may be provided at a position with which the user frequently contacts in the vehicle. For example, the haptic module 164 may be provided at the steering wheel, the gear lever, the car seats, or the like.

The memory 170 may store software programs used for the processing and controlling operations performed by the controller 190, or may temporarily store data (e.g., a phonebook, messages, still images, video, etc.) that are inputted or outputted. In addition, the memory 170 may store data regarding various patterns of vibrations and audio signals outputted when a touch is inputted to the touch screen.

The memory 170 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 170 over the Internet.

The interface unit 180 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 180 may include wired or wireless headset ports, external power supply ports, wired or wireless data ports, memory card ports, ports for connecting a device having an identification module, audio input/output (I/O) ports, video I/O ports, earphone ports, or the like.

If the mobile terminal 100 is the vehicle mobile terminal 100, the interface unit 180 may be connected to other devices mounted in the vehicle by using the format such as a controller area network (CAN), a local interconnect network (LIN), FlexRay, media oriented systems transport (MOST), and the like.

The identification module may be a chip (or other element with memory or storage capabilities) that stores various information for authenticating user's authority for using the mobile terminal 100 and may include a user identity module (UIM), a subscriber identity module (SIM) a universal subscriber identity module (USIM), and the like. In addition, the device having the identification module (referred to as the ‘identifying device’, hereinafter) may take the form of a smart card. Accordingly, the identifying device may be connected with the mobile terminal 100 via a port or other connection means. In addition, the identification device may be fabricated in the form of a vehicle key. Accordingly, the identification module may be connected to the mobile terminal 100 via a port. The interface unit 180 may be used to receive inputs (e.g., data, information, power, etc.) from an external device and transfer the received inputs to one or more elements within the mobile terminal 100 or may be used to transfer data between the mobile terminal and an external device.

In addition, when the mobile terminal 100 is connected with an external cradle, the interface unit 180 may serve as a conduit to allow power from the cradle to be supplied therethrough to the mobile terminal 100 or may serve as a conduit to allow various command signals inputted from the cradle to be transferred to the mobile terminal therethrough. Various command signals or power inputted from the cradle may operate as signals for recognizing when the mobile terminal is properly mounted on the cradle.

The controller 190 (such as a microprocessor or the like) typically controls the general operations of the mobile terminal. For example, the controller 190 performs controlling and processing associated with voice calls, data communications, video calls, and the like. In addition, the controller 190 may include a multimedia module 191 for reproducing (or playing back) multimedia data. The multimedia module 191 may be configured within the controller 190 or may be configured to be separate from the controller 190.

When the mobile terminal 100 is the vehicle mobile terminal 100, the controller 190 may include an airbag controller 192 for controlling an airbag mounted in the vehicle and an emergency battery controller 193 for controlling an emergency battery mounted in the vehicle.

The multimedia module 191, the airbag controller 192, and the emergency battery controller 193 may be implemented within the controller 190 or may be implemented separately from the controller 190.

When the mobile terminal 100 is the vehicle mobile terminal 100 and is implemented with a mobile communication technique, the mobile terminal 100 may be called a telematics terminal. In this case, the controller 190 is called a telematics control unit (TCU).

The controller 190 may perform a pattern recognition processing to recognize a handwriting input or a picture drawing input performed on the touch screen as characters or images.

The power supply unit 200 receives external power (via a power cable connection) or internal power (via a battery of the mobile terminal) and supplies appropriate power required for operating respective elements and components under the control of the controller 190.

The mobile terminal 100 may be implemented as the mobile terminal 100 that is configured to include a portion of the entirety of the elements and be carried around. Or, the mobile terminal 100 may be implemented as the vehicle mobile terminal 100 that includes a portion or the entirety of the elements and integrally fabricated with the vehicle or detachably attached to the vehicle.

The mobile terminal 100 may be implemented to be integrated with the vehicle or may be detachably attached to the vehicle as a separate device with respect to the vehicle.

Various embodiments as described herein may be implemented in a computer-readable medium using, for example, computer software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented in the controller 190.

For software implementation, the embodiments such as procedures or functions may be implemented together with separate software modules that allow performing of at least one function or operation. Software codes can be implemented by a software application (or program) written in any suitable programming language. The software codes may be stored in the memory 170 and executed by the controller 190.

As shown in FIG. 2, the user input unit 140 may receive an input selecting a certain point whose geographical information is desired to be received, from the user.

The A/V input unit 130 may serve as the user input unit 140. For example, a signal for controlling the mobile terminal may be received such that the microphone 132 converts the user's voice into an electrical voice signal and the controller 190 converts the voice signal through voice recognition.

The user input unit 140 may receive an input to change visual information displayed on the output unit 160.

If the mobile terminal 100 is the vehicle navigation terminal 100, the user can provide voice inputs to select a particular point (or location) without having to take his eyes off the road while the user is driving.

The wireless communication unit 110 may receive location information including omnidirectional visual information collected by the information collecting terminal (C) installed at the position related to the selected certain point.

The visual information collected by the information collecting terminal (C) may include a still image or video generated by capturing all the directions at one point related to the certain point.

The visual information may be updated in real time or may be captured at certain time intervals and updated.

When the information collecting terminal (C) is permanently installed at a position related to the certain point, the user of the mobile terminal 100 may be provided with a still image or video at a relatively short time period.

The wireless communication unit 110 may detect the presence or absence of the information collecting terminal (C) related to the selected certain point at the position available for communication with the mobile terminal 100.

The wireless communication unit 110 may receive a broadcast signal including advertisement information transferred from the server (S).

In addition, the wireless communication unit 110 may receive information about one or more POIs including detailed information transmitted from the server.

The controller 190 may generate visual information related to the certain point by using the received location information. The location information received via the wireless communication unit 110 may include visual information in the form of two-dimensional video or still image. The controller 190 reconfigures the received visual information to generate a three-dimensional image or video.

If the mobile terminal 100 determines that the information collecting terminal (C) exists at a position available for communication with the mobile terminal 100, the controller 190 may control the wireless communication unit 110 to receive the location information from the information collecting terminal (C).

If the mobile terminal 100 determines that the information collecting terminal (C) does not exist at a position available for communication with the mobile terminal 100, the controller 190 may control the wireless communication unit 110 to receive the location information from the server (S).

The controller 190 may control the output unit 160 to change the displayed visual information according to an input received from the user.

For example, the controller 190 may zoom in or out the displayed visual information. In addition, the controller 190 may change a time point of the displayed visual information. Changing of the time point of the displayed visual information may refer to scrolling the visual information displayed on the screen up/down and left/right. In addition, the controller 190 may add or delete supplementary information related to the certain point and displayed on the screen, or change the position displayed on the screen.

The controller 190 may control the output unit 160 to output image information, voice information and supplementary information included in the received advertisement information.

In addition, when the output advertisement information is selected via the user input unit 140, the controller 190 may automatically link the mobile terminal 100to a home page address or a shopping mall home page address corresponding to the corresponding advertisement information and control the output unit 160 to output the link result.

When a particular point of interest (POI) displayed on the output unit 160 is selected via the user input unit 140, the controller 190 controls the output unit 160 to output detailed information regarding the corresponding POI or perform a function corresponding to the POI. Here, the detailed information regarding the POI may include the name of the POI, location (including latitude or longitude), address, phone number, simple explanation information of the POI, drawing of each layer, and the like.

In addition, when the particular POI is selected as a destination via the user input unit 140, the controller 190 may generate road guidance information up to the entrance of the POI or the entrance of a parking lot of the POI based on detailed information (including entrance/exit information of a building, entrance/exit information of a parking lot, information about a zone available for parking) included in the POI, and output the generated road guidance information via the output unit 160.

The output unit 160 may display the visual information generated by the controller 190. The output unit 160 may include the display unit 161.

The display unit 161 may display a still image or a video viewed at one point related to the certain point at an arbitrary time point. The still image or video may be three-dimensionally reconfigured and displayed. The one point related to the certain point may be the same point as the point where the information collecting terminal (C).

The display unit 161 may display supplementary information related to the certain point. The supplementary information may include address, latitude and longitude of the certain point, the direction at a certain time point, the time at which the visual information was captured, and an anticipated travel route of the user of the mobile terminal.

The output unit 160 may include the audio output module 162 for outputting by voice the supplementary information related to the certain point.

The output unit 160 may output additional information related to the displayed visual information. The additional information may be information related to the POI displayed on the visual information.

The information related to the POI may include latitude, longitude, address, features, phone number, web address, and the like, of the POI.

The output unit 160 may include the display unit 161 for displaying the additional information related to the displayed visual information or the audio output module 162 for outputting by voice the additional information.

The memory 170 may store the location information including the visual information received at a certain point by using the wireless communication unit 110 or a broadcast signal including the advertisement information. In this case, the location information or the broadcast signal may be stored in the memory 170, may be transmitted from the server at pre-set time intervals and stored, or may be transmitted from the server and stored in response to a request from the mobile terminal 100.

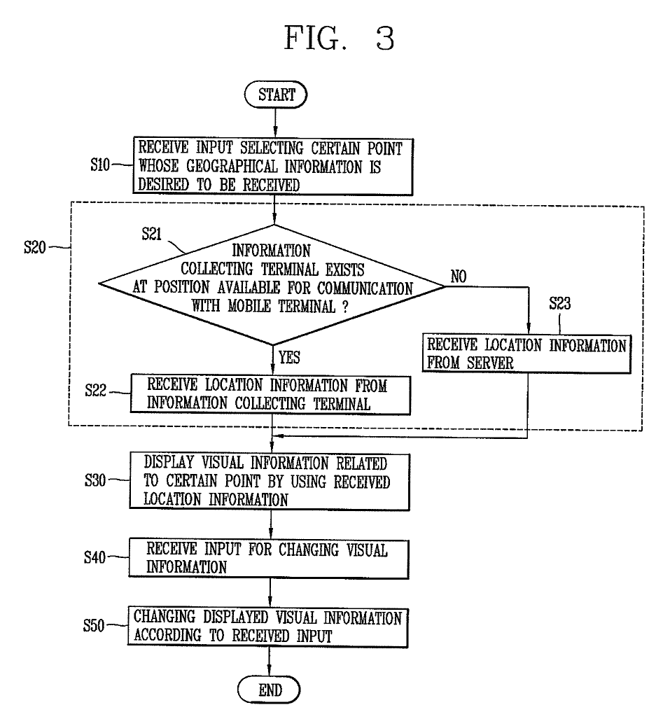

FIG. 3 is a flow chart illustrating the process of a method for providing a LBS for the mobile terminal according to a first embodiment of the present invention.

As shown in FIG. 3, the mobile terminal 100 may receive an input selecting a certain point whose geographical information is desired to be received. The input may be received from the user or from a different terminal (S10).

Thereafter, when the mobile terminal 100 receives the input selecting the certain point, the mobile terminal 100 requests a transmission of location information from the information collecting terminal (C) installed at a position related to the certain point or from a server or from the memory 170, and receives the location information including the omnidirectional visual information with respect to the certain point.

In more detail, when the mobile terminal 100 receives the input selecting the certain point, the mobile terminal may obtain the visual information corresponding to the certain point (S20).

In step S20 of receiving the location information, the mobile terminal 100 may determine whether or not the information collecting terminal (C) exists at a position available for communication with the mobile terminal 100 (S21). If the information collecting terminal (C) exists at a position available for communication with the mobile terminal 100, the mobile terminal 100 may receive the location information transmitted from the information collecting terminal (C) (S22). If the information collecting terminal (C) does not exist at a position available for communication with the mobile terminal 100, the mobile terminal 100 may request transmission of location information including visual information related to the certain point stored in the server from the server and receive location information transmitted from the server (S23). The mobile terminal 100 may also retrieve previously received visual information from the memory 170.

Upon receiving the location information, the mobile terminal 100 displays the visual information related to the certain point on the display unit 161 by using the received location information. The visual information may include supplementary information related to the certain point. Here, the supplementary information related to the certain point may include address, latitude and longitude of the certain point, the direction at a certain time point, time at which the visual information was captured, and an anticipated travel route of the user of the mobile terminal (S30).

The mobile terminal 100 may receive an input that changes the visual information. The change in the visual information may include zooming-in on the displayed visual information, zooming-out from the displayed visual information, a change in the time point of the displayed visual information, addition and deletion of the supplementary information related to the certain point, a change in the position on the screen, and the like (S40).

The mobile terminal may change the displayed visual information according to the received input (S50).

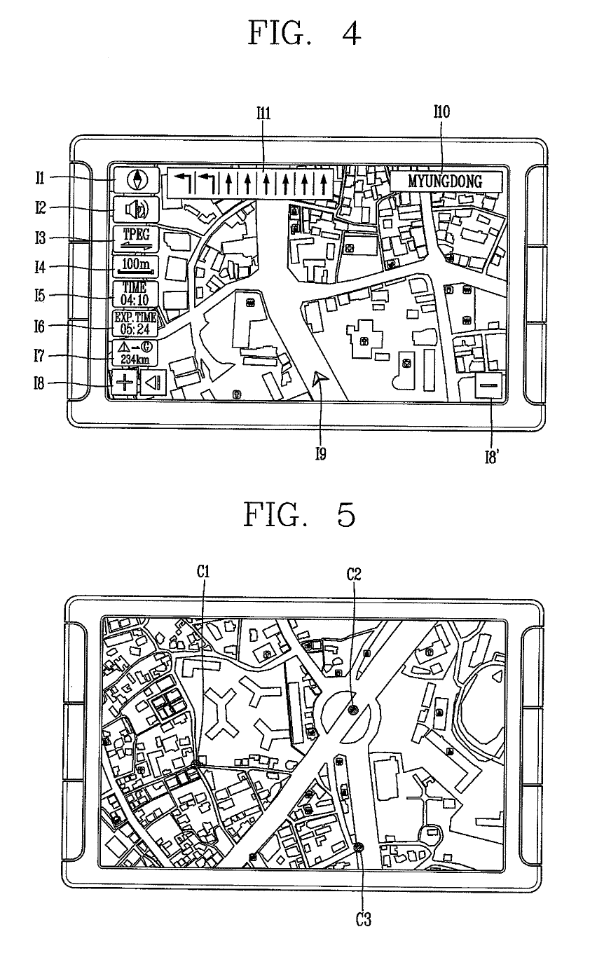

FIG. 4 is an overview of a display screen of the mobile terminal according to an embodiment of the present invention.

The screen image as shown in FIG. 4 may be used when the mobile terminal 100 is the navigation terminal 100. When the mobile terminal 100 is implemented in the form of a mobile phone, a smart phone, a notebook computer, a digital broadcast terminal, a PDA, a PMP, and the like, that the user can carry around, only a portion the elements shown in FIG. 4 may be displayed, or none of the elements may not be displayed.

As shown in FIG. 4, the display unit 161 may display the icon I1 indicating the direction of a map displayed at one region of the screen. The display unit 161 may display the map such that a particular direction (e.g., the direction of true north of the earth), a proceeding direction of a moving object, a direction in which a destination is located, and the like, are fixedly displayed at an upper portion of the screen.

The display unit 161 may display an icon I2 indicating whether or not the audio output module 162 is activated or whether or not the volume of the audio output module 162 has been set at one region of the screen. The user may activate or deactivate the audio output module 162 or adjust the volume of the audio output module 182 by applying a touch input to the icon I2.

The display unit 161 may display an icon I3 indicating whether or not a route search function (e.g., using a transport portal experts group (TPEG) protocol) is activated at one region of the screen. TPEG refers to traffic information protocols established by a European broadcasting union in 1997. However, in the navigation system of the present embodiment, the TPEG is known as a route guidance function using real time traffic situation information.

The display unit 161 may display an icon I4 indicating the scale of the map data at one region of the screen.

The display unit 161 may display an icon I5 indicating a current time at one region of the screen. The display unit 161 may display an icon I6 indicating an expected time at which the user may reach a pre-set destination at one region of the screen. Besides, an icon indicating a required time expected to reach the pre-set destination.

The display unit 161 may display an icon I7 at one region of the screen in order to indicate the distance remaining to reach the pre-set destination.

The display unit 161 may display an icon I8 for scaling up the map displayed on one region of the screen and an icon I8′ for reducing the map.

The display unit 161 may display an icon I9 indicating the position and a proceeding direction of the moving object at one region of the screen. Also, the proceeding direction of the moving object may be displayed in a vertex direction of the arrow in the icon I9.

The display unit 161 may display an icon I10 indicating a geographical name of an area where the moving object is located at one region of the screen.

The display unit 161 may display an icon I11 indicating a configuration of traffic lanes.

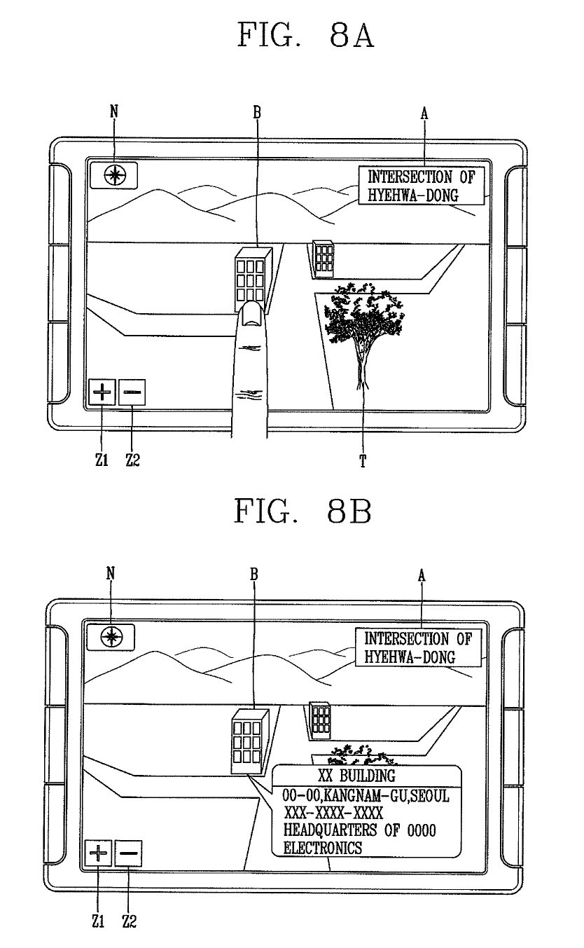

The display unit 161 may display a route required to reach a pre-set destination (112 in FIG. 8).

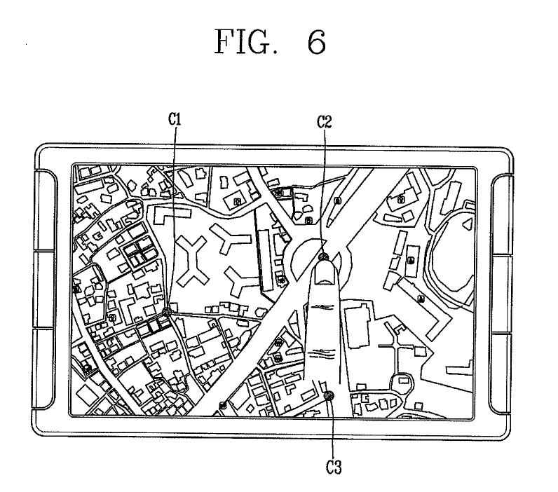

FIG. 5 is an overview of a display screen illustrating an indication of a certain point where the information collecting terminal is installed according to an embodiment of the present invention.

As shown in FIG. 5, the mobile terminal 100 may display on the map locations of certain points C1, C2, and C3 where the information collecting terminal (C) is installed.

The location-based service server (S) may store information about the locations of the certain points C1, C2, and C3 where the information collecting terminal (C) are installed. The location-based service server (S) may receive the location information transmitted in real time or at pre-set time intervals from the respective information collecting terminals (C) corresponding to the certain points.

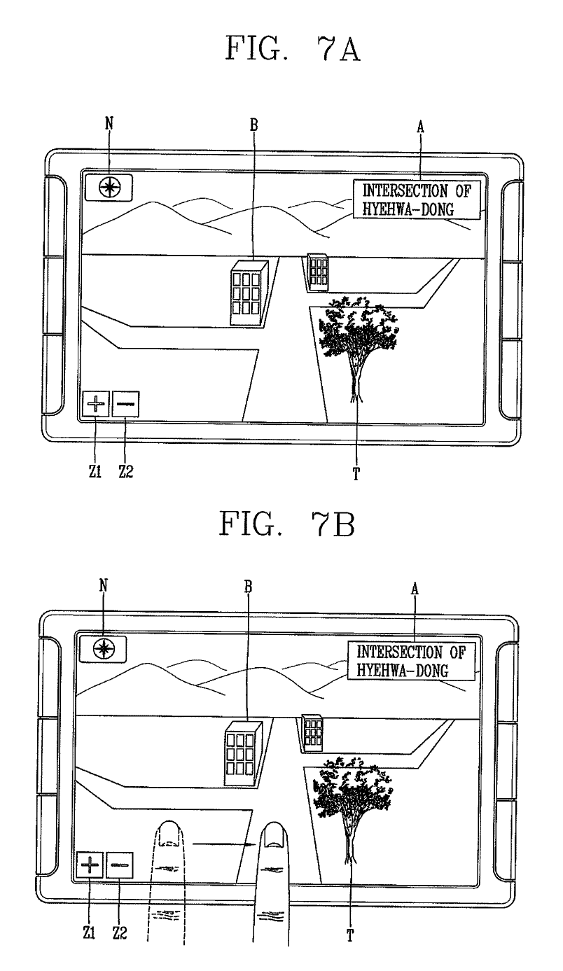

FIG. 6 is an overview of a display screen illustrating a selection of one of the certain points by the user of the mobile terminal according to an embodiment of the present invention.

As shown in FIG. 6, the user of the mobile terminal 100 selects one (C2) of the certain points (C1, C2, and C3). The mobile terminal 100 may attempt to receive the location information including visual information collected by the information collecting terminal (C) installed at a location related to the selected certain point (C2).

As shown in FIG. 6, the user may select the certain point (C2) by applying a touch input to the touch pad implemented on the display unit 161 of the mobile terminal 100. Other selection techniques may also be used, such as a joy stick, cursor, etc.

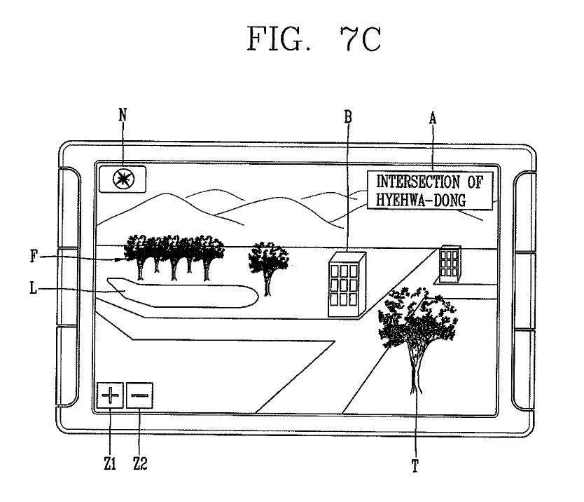

FIGS. 7a to 7c are overviews of display screens illustrating the display of visual information in the mobile terminal according to an embodiment of the present invention.

As shown in FIG. 7a, the mobile terminal 100 may display a graphical indicator that shows coordinates or directional orientation (N) (such as, a compass-like icon with a heading indication for North) at one portion (e.g. upper left-hand corner) of the screen together with the image (still image, moving image, video capture image, animation, graphics, etc.) showing a view of the user's travel (moving) direction. The directional orientation (N) may refer to a direction that the camera that has captured the still image or a direction that the video is directed.

The mobile terminal 100 may display the address of the certain point or the name of the place (A) on one region of the screen. Or, the mobile terminal may simultaneously or alternatively display the latitude/longitude of the certain point in place of the name of the place (A) according to a user selection.

Also, with the name of the place (A) displayed, if the displayed region is clicked, the mobile terminal may display a latitude/longitude and the like of a certain point in addition to or instead of the displayed name of the place (A). Namely, when the corresponding region is clicked, the name and the latitude/longitude may be displayed simultaneously or alternately.

The mobile terminal 100 may display an icon for scaling up (Z) or down (Z2) a still image or video displayed on the screen.

As shown in FIG. 7a, a certain building (B) and a tree (T) are included in the still image or video.

As shown in FIG. 7b, the user of the mobile terminal 100 may input a signal for changing the still image or video displayed on the screen. As shown in FIG. 7b, the user of the mobile terminal 100 may input a signal for changing a time point of the still image or video displayed on the screen. The signal may be inputted through a touch input or may be inputted by another means (e.g., manipulating a hard key disposed on the mobile terminal 100) by the user.

As shown in FIG. 7c, the mobile terminal 100 may change the still image or video displayed on the screen according to the input. For example, the mobile terminal 100 may display a still image or video from a point of time different from that of the still image or video displayed on the screen as shown in FIG. 7a. To this end, the location information received from the information collecting device (C) must include visual information obtained by capturing all directions based on the certain point.

As shown in FIG. 7c, the still image or video of a different time point from that of the still image or video displayed on FIG. 7a may include a forest (F), a lake (L), and the like, that the still image or video displayed on FIG. 7a does not have.

The direction (N) may be changed according to a change in the time point of the still image or video.

FIGS. 8a and 8b are overviews of display screens illustrating additional information in a navigation terminal according to an embodiment of the present invention.

As shown in FIG. 8a, the mobile terminal 100 may receive an input from the user for selecting one or more POIs displayed on the screen.

The mobile terminal 100 may display the selected POI differently from other elements of the screen. For example, the name of the POI may be displayed, the outline of the POI may be displayed differently from other objects (for example, the outline of the POI is displayed to be thick), or the POI may be displayed in a different color from other objects.

As shown in FIG. 8b, the mobile terminal 100 may output additional information related to the selected POI. FIG. 8b shows the additional information displayed on the screen of the display unit 161, but the additional information may be outputted in voice by the audio output module 162.

The additional information may include the latitude, longitude, address, features, a phone number, web address, opening/closing times, or the like, of the POI.

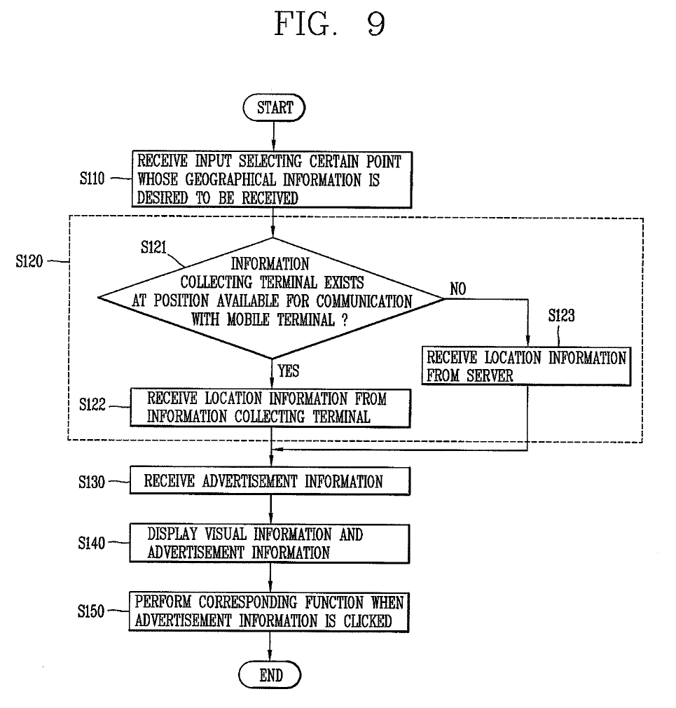

FIG. 9 is a flow chart illustrating a method for providing a LBS for the mobile terminal according to a second embodiment of the present invention.

First, the mobile terminal 100 may receive an input selecting a certain point whose geographical information is desired to be received. The input may be received from the user or a different terminal (S110).

Thereafter, when the mobile terminal 100 receives an input selecting the certain point, the mobile terminal 100 requests transmission of location information from the information collecting terminal (C) installed at a position related to the certain point and receives location information including visual information about the certain point transmitted from the information collecting terminal (C). In this case, the information collecting terminal (C) collects and stores omnidirectional visual information at the certain point.

When the mobile terminal 100 receives the input selecting the certain point, the mobile terminal 100 may extract the visual information corresponding to the certain point stored in the memory 170 (S120).

In step S120, the mobile terminal 100 may determine whether or not the information collecting terminal (C) exists at a position available for communication with the mobile terminal 100 (S121). If the information collecting terminal (C) exists at a position available for communication with the mobile terminal 100, the mobile terminal 100 may receive the location information transmitted from the information collecting terminal (C) (S122). If the information collecting terminal (C) does not exist at a position available for communication with the mobile terminal 100, the mobile terminal 100 may request transmission of location information including visual information related to the certain point stored in the server from the server and receive location information transmitted from the server (S123).

In addition, the mobile terminal 100 may receive a broadcast signal including advertisement information transmitted from the server by using the broadcast receiving module 111 and the like.

The broadcast signal received by the mobile terminal 100 may include specific advertisement information related to the certain point. For example, if the certain point is a building of LG Inc., the broadcast signal received by the mobile terminal 100 may include advertisement information including video information, voice information and supplementary information related to the LG Inc. For another example, if the certain point is a City Hall, the broadcast signal received by the mobile terminal 100 may include advertisement information including image information, voice information and supplementary information about certain stores randomly or sequentially selected from among advertisement information about a plurality of stores located within a pre-set radius from the City Hall. In addition, as the advertisement information included in the received broadcast signal, advertisement information reflecting a pre-set preference of the user may be received.

In addition, the broadcast signal received by the mobile terminal 100 may include advertisement information including image information, voice information and supplementary information about certain stores randomly or sequentially selected from among advertisement information about a plurality of stores stored in the server.

The supplementary information included in the advertisement information may include at least one of the name of a store, the location of the store, a phone number of the store, store operating hours, brief explanation of the store, image information (including company logo, emoticon, and the like) corresponding to the image and voice information.

Also, the supplementary information included in the advertisement information may include uniform resource locator (URL) information about the corresponding store or URL information about a shopping mall that sells goods related to the corresponding store.

The server may include various terminals that may collect and store various information such as a location-based service server, a broadcast management server, a terminal installed at a traffic light, a street light, a stop sign, an information providing center, an advertisement providing server (or an outdoor advertisement server), etc.

The server may include a certain mobile terminal (phone-to-phone connection), a vehicle terminal (phone-to-car connection), and the like, that may be connected by using the short-range communication module 114 (S130).

Thereafter, when the location information and broadcast signal are received, the mobile terminal 100 may display visual information related to the certain point on the display unit 161 by using the received location information. The visual information may include supplementary information related to the certain point. The supplementary information related to the certain point may include address, latitude and longitude of the certain point, the direction at a certain time point, time at which the visual information was captured, and an anticipated travel route of the user of the mobile terminal.

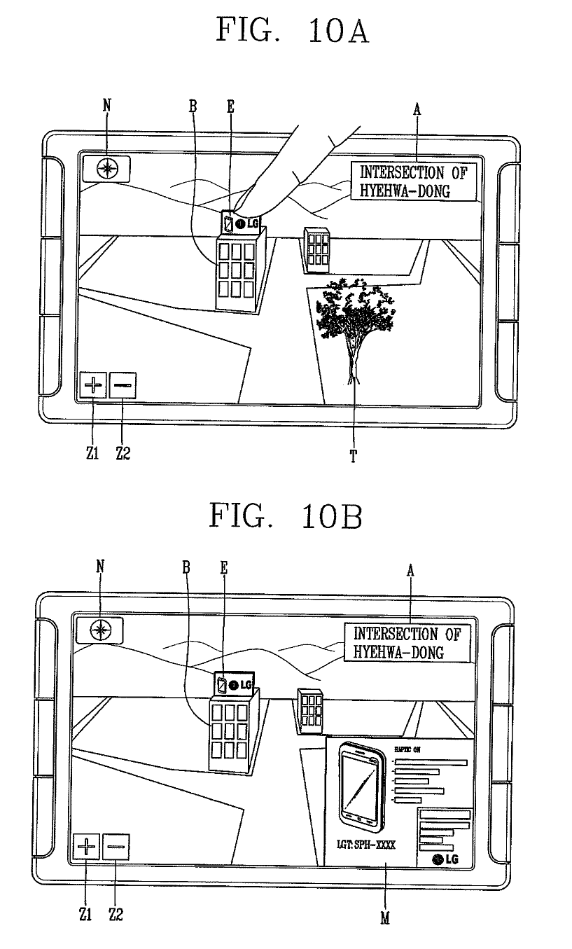

In addition, the mobile terminal 100 may display advertisement information included in the received broadcast signal as well as the visual information related to the certain point. As shown in FIG. 10a, the displayed advertisement information (E) may be configured to overlap with the visual information (S140).

Thereafter, when the region (E) of the displayed advertisement information is selected (or touched) by the user, the mobile terminal 100 may display the supplementary information included in the corresponding advertisement information or perform a function corresponding to the supplementary information.

For example, as shown in FIG. 10b, when the region (E) of the displayed advertisement information is touched by the user, the mobile terminal 100 displays supplementary information (M) including at least one of the name of a store, the location of the store, a phone number of the store, brief explanation of the store, image information (including company logo, emoticon, and the like) corresponding to the advertisement information on a region of the display unit 161.

For another example, when the region (E) of the displayed advertisement information is touched by the user, the mobile terminal automatically connects to a homepage address (or URL) of the corresponding store by using a Web browser and the like, and displays the homepage on the entire region or a partial region of the display unit 161.

For another example, when the region (E) of the displayed advertisement information is touched by the user, the mobile terminal automatically connects to a homepage address (or URL) of a shopping mall that sells goods related to the corresponding store by using a Web browser and the like, and displays the homepage on the entire region or a partial region of the display unit 161.

The mobile terminal 100 may receive an input that changes the visual information. The change in the visual information may include zooming-in on the displayed visual information, zooming-out from the displayed visual information, a change in a time point of the displayed visual information, an addition and deletion of the supplementary information related to the certain point, a change in the position on the screen, and the like.

Thereafter, the mobile terminal may change the displayed visual information according to the received input (S170).

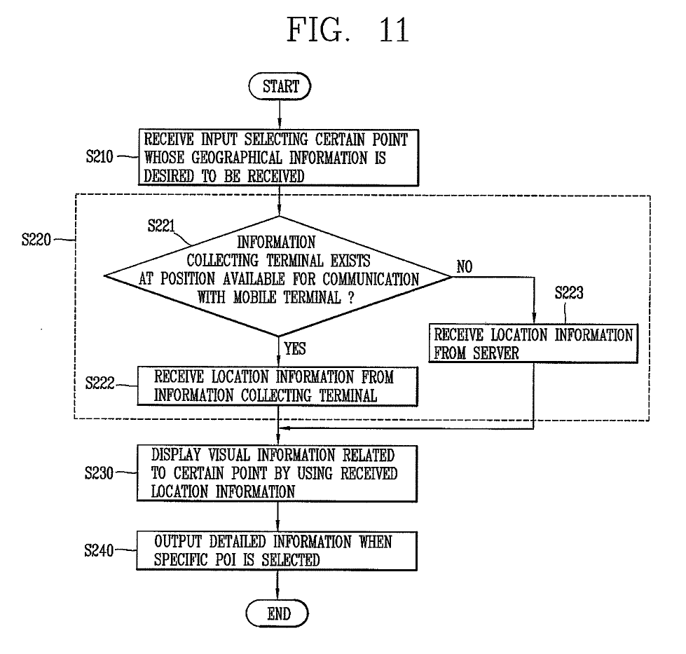

FIG. 11 is a flow chart illustrating a method for providing a LBS for the mobile terminal according to a third embodiment of the present invention.

First, the mobile terminal 100 may receive an input selecting a certain point whose geographical information is desired to be received. The input may be received from the user or from a different terminal (S210).

Thereafter, when the mobile terminal 100 receives the input selecting the certain point, the mobile terminal 100 requests a transmission of location information from the information collecting terminal (C) installed at a position related to the certain point. Subsequently, the mobile terminal 100 receives the location information including the visual information with respect to the certain point transmitted from the information collecting terminal (C). At this time, the information collecting terminal (C) collects and stores the omnidirectional visual information at the certain point.

When the mobile terminal 100 receives the input selecting the certain point, the mobile terminal may extract the visual information corresponding to the certain point stored in the memory 170 to use it (S220).

In step S220, the mobile terminal 100 may determine whether or not the information collecting terminal (C) exists at a position available for communication with the mobile terminal 100 (S221). If the information collecting terminal (C) exists at a position available for communication with the mobile terminal 100, the mobile terminal 100 may receive the location information transmitted from the information collecting terminal (C) (S222). If the information collecting terminal (C) does not exist at a position available for communication with the mobile terminal 100, the mobile terminal 100 may request and receive a transmission of location information including visual information related to the certain point from the server (S223).

Also, the server may include various terminals that may collect and store various information such as a location-based service server, a broadcast management server, a terminal installed at a traffic light, a street light, a stop sign, an information providing center, an advertisement providing server (or an outdoor advertisement server), etc.

Upon receiving the location information, the mobile terminal 100 displays the visual information related to the certain point on the display unit 161 by using the received location information. The visual information may include supplementary information related to the certain point. Here, the supplementary information related to the certain point may include an address, a latitude and longitude of the certain point, the direction at a certain time point, the time at which the visual information was captured, and an anticipated travel route of the user of the mobile terminal (S230).

Also, the visual information may include detailed information about one or more POIs. The detailed information about the POI may include the name of the corresponding POI, a location (including latitude or longitude), an address, a phone number, a brief description information of the POI, or a drawing of each floor (including a plan view of each layer, an elevation view of each layer (including front, side and rear views), a development figure of each layer, a projection view of each layer, etc.).

Thereafter, when a specific POI is selected from the visual information related to the certain point displayed on the display unit 161 is selected, the mobile terminal displays detailed information about the selected specific POI.

For example, if a certain building of a department store is selected from visual information displayed on the display unit 161, the mobile terminal 100 displays a three-dimensional drawing with respect to the corresponding building such as a plan view of each layer, an elevation view of each layer (including front, side and rear views), a development figure of each layer, a projection view of each layer, and the like, of the selected building of the department store on the display unit 161. At this time, a detailed drawing of the corresponding building displayed on the display unit 161 may include information about a parking lot located inside or outside of the corresponding building (including entrance/exit information and information about a parking available area), and information about an entrance/exit of the corresponding building. In addition, the function of zooming-in or zooming-out may be applied to the detailed drawing of the displayed corresponding building.

The detailed information about one or more POIs may be transmitted from the server in response to a request of the mobile terminal 100.

The detailed information about one or more POIs may be transmitted in real time or at pre-set time intervals through a connection for communication between the mobile terminal 100 and the information collecting terminal (C) provided in the specific POI. For example, if the specific POI is a department store, image information and/or voice information obtained by a plurality of cameras installed within the department store may be transmitted in real time to the mobile terminal 100, and the mobile terminal 100 receives the transmitted video information and voice information. Thereafter, the mobile terminal may output the received image and/or voice information via the display unit 161 and the audio output module 162.

With such a configuration, the user of the mobile terminal 100 may easily check information about the entrance/exit of the building, the entrance/exit of the parking lot, and the parking available area with respect to the user-selected specific POI.

With such a configuration, the user of the mobile terminal may check image information and/or voice information obtained within the specific POI transmitted in real time.

The mobile terminal 100 may receive an input that changes the visual information. The change in the visual information may include zooming-in of the displayed visual information, zooming-out of the displayed visual information, a change in the time point of the displayed visual information, addition and deletion of the supplementary information related to the certain point, a change in the position on the screen, and the like.

Thereafter, the mobile terminal may change the displayed visual information according to the received input (S240).

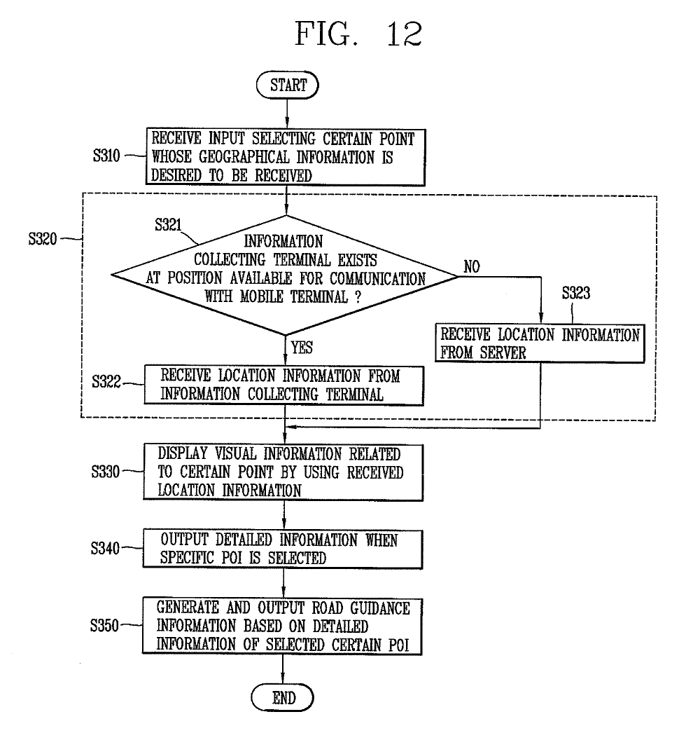

FIG. 12 is a flow chart illustrating a method for providing a LBS for the mobile terminal according to a fourth embodiment of the present invention.

First, the mobile terminal 100 may receive an input selecting a certain point whose geographical information is desired to be received. The input may be received from the user or from a different terminal (S310).

Thereafter, when the mobile terminal 100 receives the input selecting the certain point, the mobile terminal 100 requests transmission of location information from the information collecting terminal (C) installed at a position related to the certain point. Subsequently, the mobile terminal 100 receives the location information including the visual information with respect to the certain point transmitted from the information collecting terminal (C). At this time, the information collecting terminal (C) collects and stores the omnidirectional visual information at the certain point.

When the mobile terminal 100 receives the input selecting the certain point, the mobile terminal may extract the visual information corresponding to the certain point stored in the memory 170 to use it (S320).

In step S220, the mobile terminal 100 may determine whether or not the information collecting terminal (C) exists at a position available for communication with the mobile terminal 100 (S321). If the information collecting terminal (C) exists at a position available for communication with the mobile terminal 100, the mobile terminal 100 may receive the location information transmitted from the information collecting terminal (C) (S322). If the information collecting terminal (C) does not exist at a position available for communication with the mobile terminal 100, the mobile terminal 100 may request transmission of location information from the server (S323).

Also, the server may include various terminals that may collect and store various information such as a location-based service server, a broadcast management server, a terminal installed at a traffic light, a street light, a stop sign, an information providing center, an advertisement providing server (or an outdoor advertisement server), etc.

Upon receiving the location information, the mobile terminal 100 displays the visual information related to the certain point on the display unit 161 by using the received location information. The visual information may include supplementary information related to the certain point. Here, the supplementary information related to the certain point may include an address, a latitude and longitude of the certain point, the direction at a certain time point, a time at which the visual information was captured, and an anticipated travel route of the user of the mobile terminal.

Also, the visual information may include detailed information about one or more POIs. The detailed information about the POI may include the name of the corresponding POI, a location (including latitude or longitude), an address, a phone number, a brief description information of the POI, a drawing of each floor (including a plan view of each layer, an elevation view of each layer (including front, side and rear views), a development figure of each layer, a projection view of each layer), information about entrance/exit of the corresponding POI, information about entrance/exit of a parking lot located inside/outside of the corresponding POI, information about a parking available area, and the like (S330).

Thereafter, when a specific POI is selected from the visual information related to the certain point displayed on the display unit 161 is selected, the mobile terminal displays detailed information about the selected specific POI.

For example, if a certain building (POI) is selected from the visual information displayed on the display unit 161, the mobile terminal may display the detailed information about the selected building on the display unit 161.

The detailed information about one or more POIs may be transmitted from the server in response to a request of the mobile terminal 100 (S340).

Thereafter, when the entrance of a parking lot of the corresponding building or an entrance/exit of the corresponding building displayed on the display unit 161 is selected as a destination by the user, the mobile terminal 100 generates road guidance information based on the current location of the mobile terminal 100 and the destination information (including the information about the entrance/exit of the POI or the entrance/exit of the parking lot), and outputs the generated road guidance information to the display unit 161 and/or the audio output module 162.

With such a configuration, the user of the mobile terminal 100 may be provided accurate route guidance to the desired destination.

The mobile terminal 100 may receive an input that changes the visual information. The change in the visual information may include zooming-in on the displayed visual information, zooming-out from the displayed visual information, a change in the time point of the displayed visual information, an addition and deletion of the supplementary information related to the certain point, a change in the position on the screen, and the like.

Thereafter, the mobile terminal may change the displayed visual information according to the received input (S350).

As so far described above, the mobile terminal and the method for providing a location-based service of the mobile terminal have many advantages.

That is, first, because an image of omnidirectional visual information related to a certain point is captured, reconfigured, and provided to the user, the user can receive the location information of presence.

Second, omnidirectional visual information or advertisement information related to a certain point may be stored in the memory of the mobile terminal.

The omnidirectional visual information or advertisement information related to the certain point may be transmitted at pre-set time intervals from the server or may be transmitted from the server in response to a request from the mobile terminal.

In an embodiment of the present invention, the above-described method can be implemented as codes that can be read by a computer in a program-recorded medium. The computer-readable medium may include various types of recording devices in which data that can be read by a computer system is stored. The computer-readable medium may include a ROM, a RAM, a CD-ROM, a magnetic tape, a floppy disk, an optical data storage device, and the like. The computer-readable medium also includes implementations in the form of carrier waves or signals (e.g., transmission via the Internet).

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a user input unit configured to receive an input selecting a certain point for which geographical information is desired to be received;
a wireless communication unit configured to receive location information corresponding to the certain point and maintained in a server or collected by an information collecting terminal installed at a position related to the certain point, the location information including omnidirectional or other image data;
a controller configured to generate visual information related to the certain point based on the received location information; and
an output unit configured to display the generated visual information.

2. The mobile terminal of claim 1, wherein the omnidirectional or other image data comprises a still image or a video related to the certain point.

3. The mobile terminal of claim 1, wherein the wireless communication unit is configured to detect whether or not the mobile terminal is able to communicate with the, information collecting terminal, and if the mobile terminal is able to communicate with the information collecting terminal, the controller is configured to control the wireless communication unit to receive the location information from the information collecting terminal.

4. The mobile terminal of claim 3, wherein if the mobile terminal is not able to communicate with the information collecting terminal, the controller is configured to control the wireless communication unit to receive the location information from the server.

5. The mobile terminal of claim 1, wherein the output unit comprises a display unit configured to display a still image or a video related to the certain point.

6. The mobile terminal of claim 5, wherein the displayed visual information comprises supplementary information related to the certain point.

7. The mobile terminal of claim 6, wherein the supplementary information comprises at least one of an address, a latitude and longitude of the certain point, a direction at a certain time point, a time at which the omnidirectional or other image data was captured, and an anticipated travel route of a user of the mobile terminal.

8. The mobile terminal of claim 1, wherein the user input unit is configured to receive an input changing the displayed visual information, and the controller is configured to control the output unit to change the displayed visual information according to the received input.

9. The mobile terminal of claim 8, wherein the change in the displayed visual information comprises at least one of zooming-in to the displayed visual information, zooming-out from the displayed visual information, a change in the time point of the displayed visual information, an addition or deletion of the supplementary information related to the certain point, and a change in a position on the screen.

10. The mobile terminal of claim 1, wherein the output unit is configured to output additional information related to the displayed visual information.

11. The mobile terminal of claim 10, wherein the output unit comprises:
an audio output module configured to provide the additional information by voice.

12. The mobile terminal of claim 1, wherein the user input unit comprises:
a microphone configured to receive a voice input of a user,
wherein the controller is configured to react to the user's voice input through voice recognition.

13. A method for providing a location-based service to a mobile terminal, the method comprising:
receiving at the mobile terminal an input selecting a certain point for which geographical information is desired;
wirelessly receiving location information corresponding to the certain point and maintained in a server or collected by an information collecting terminal installed at a position related to the certain point, the location information including omnidirectional or other image data; and
displaying visual information related to the certain point based on the received location information.

14. The method of claim 13, wherein the omnidirectional or other image data comprises omnidirectional or other image data collected by one or more cameras of the information collecting terminal.

15. The method of claim 13, wherein the step of receiving comprises:
determining whether or not the mobile terminal is able to communicate with the information collecting terminal;
if the mobile terminal is able to communicate with the information collecting terminal, receiving the location information from the information collecting terminal; and
if the mobile terminal is not able to communicate with the information collecting terminal, receiving the location information from the server.

16. The method of claim 13, further comprising:
changing the displayed information according to a received input.

17. The method of claim 13, further comprising:
displaying additional information related to the displayed visual information.

18. A motor vehicle, comprising:
a navigation unit, including
a user input unit configured to receive an input selecting a certain point for which geographical information is desired to be received;
a wireless communication unit configured to receive location information corresponding to the certain point and maintained in a server or collected by an information collecting terminal installed at a position related to the certain point, the location information including omnidirectional or other image data;
a controller configured to generate visual information related to the certain point based on the received location information; and
an output unit configured to display the generated visual information.
